(19) United States
(12) Patent Application Publication
(10) Pub. No.: US 2006/0017196 A1
(43) Pub. Date: Jan. 26, 2006

(54) Manufacture of papermachine clothing

(75) Inventor: Ian Sayers, Lancashire (GB)

Correspondence Address: GREENBLUM & BERNSTEIN, P.L.C., 1950 ROLAND CLARKE PLACE, RESTON, VA, 20191, US

(73) Assignee: Voith Fabrics Patent GmbH, Heidenheim (DE)

(21) Appl. No.: 11/184,902

(22) Filed: Jul. 20, 2005

(30) Foreign Application Priority Data
Jul. 21, 2004 (DE) 10 2004 035 370.0

(51) Int. Cl. B27N 1/00

(52) U.S. Cl. 264/259; 264/460; 264/518; 425/174.8 E

(57) ABSTRACT

A method of manufacturing papermachine clothing including electrostatically charging selected areas of an electrostatically chargeable surface. Applying a dry material to the surface, wherein the dry material adheres to the selected areas, then removing non-adhering material. Melting the dry material adhering to the selected areas, and applying the molten dry material to an extended surface to form a planar article. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 10 2004 035 370.0, filed on Jul. 21, 2004, the disclosure of which is expressly incorporated by reference herein in its entirety.

### BACKGROUND OF THE INVENTION

1. Field of the Invention

The invention relates to the manufacture of papermachine clothing and other industrial fabrics, such as forming fabrics, press felts, dryer fabrics, through-air dryer (TAD) fabrics, hydroentanglement screens and transfer fabrics for use in a papermachine.

This invention relates to the manufacture of papermachine clothing and other industrial fabrics, such as forming fabrics, press felts, dryer fabrics, through-air dryer (TAD) fabrics, hydroentanglement screens and transfer fabrics for use in a papermachine. The fabrics of the invention also have application as transfer/conveyor fabrics in machines other than papermachines and may be used, for example, as conveying fabrics, or as screens for latex impregnation of conventionally air-laid materials, for support or formation screens used in melt blowing or spun bonded nonwoven fabric manufacture.

2. Discussion of Background Information

Paper is conventionally manufactured by conveying a paper furnish, usually composed of an initial slurry of cellulosic fibers, on a forming fabric or between two forming fabrics in a forming section. The nascent sheet then can be passed through a pressing section and ultimately through a drying section of a papermaking machine. In the case of standard tissue paper machines, the paper web is transferred from the press fabric to a Yankee dryer cylinder and then creped. Alternatively, on more modern machines, a monofilament woven mesh dryer fabric conveys the web from the forming fabric to a through-air dryer, followed by a Yankee cylinder.

Papermachine clothing is essentially employed to carry the paper web through these various stages of the papermaking machine and to facilitate water removal from the sheet in a controlled manner. In the forming section, the fibrous furnish is wet-laid onto a moving forming wire and water is encouraged to drain from it through suction boxes and foils. The paper web is then transferred to a press fabric that conveys it through the pressing section, where it may pass through a series of pressure nips formed by rotating cylindrical press rolls. Water is squeezed from the paper web and into the press fabric as the web and fabric pass through the nip together. In the final stage, the paper web is transferred either to a Yankee dryer, in the case of tissue paper manufacture, or to a set of dryer cylinders upon which, aided by the clamping action of the dryer fabric, the majority of the remaining water is evaporated.

Papermachine fabrics traditionally consist of a woven fabric. As the warp and weft yarns interweave, a so-called “knuckle” is formed as they cross. These knuckles have a tendency to mark the paper sheet formed on the fabric. This problem is particularly apparent at the wet end of the papermachine where the sheet is still highly plastic. In recent years, various methods have been suggested for making nonwoven papermachine fabrics in order to eradicate the problem associated with knuckle marking, particularly for press and dryer section applications. Many of these have been impractical to manufacture commercially.

GB 1,053,954 describes a nonwoven papermaker fabric comprising two layers of parallel polymeric filaments. The layers are attached together in such a manner that the filaments of one layer are disposed at an angle with respect to the filaments in another layer. Such an arrangement is not durable and consequently this fabric is not commercially viable.

U.S. Pat. No. 3,617,442 describes a forming fabric comprising a sheet of synthetic, open-celled, flexible foam such as polyurethane. This is reinforced by a series of polyester cables, a coarse wire screen or a thin flexible metal or plastic sheet. Such an arrangement, if ever commercialized, would exhibit poor wear resistance.

GB 2,051,154 relates to a so-called “link belt” in which a base fabric is formed from a series of interdigitated helices joined together by pintle wires. Link belts are only suitable for certain applications, due to calliper and material restrictions.

U.S. Pat. No. 4,541,895 describes a papermaker fabric made up of a plurality of nonwoven sheets laminated together to define a fabric or belt. The nonwoven sheets are perforated by laser drilling. Such sheets are composed of unoriented polymer material, and if produced in the fineness needed for papermaking applications, would lack sufficient dimensional stability to operate as endless belts on papermachines.

The subject invention of GB 2,235,705 describes a base fabric for press felts. Here an array of sheath core yarns of which the core has a higher melting point than the sheath, is fed in spaced parallel disposition to peripheral grooves of a press roller arranged in nip-forming relationship with a press roll. The material of the sheath is melted as the yarns move into and through the roller nip. Further, excess melted sheath material is forced into lateral and vacant circumferential grooves in the roller to form structural members between adjacent yarns. A wide belt may be formed by joining similar strips together. A batt of fibres is subsequently needled to the base fabric so as to form a press felt. Perforations through the mesh-like base fabric extend straight through the fabric. This is undesirable for adaptation to paper sheet formation, where controlled dewatering is required, especially during the delicate sheet forming phase.

GB 2,241,915 relates to a method of producing a papermaking fabric in which a layer of photopolymeric resin is applied to a moving band. A moving, selectively transparent, mask is positioned above the resin and the resin is irradiated through the mask to effect an at least partial cure of the parts of the resin layer in register with the transparent regions of the mask. After irradiation uncured regions of the resin are removed by pressure fluid jets and final curing of the resin is effected either thermally or by flooding actinic radiation. The foraminous sheet so formed may be reinforced with yarns or fibers. Once again holes extend straight through the fabric. This is undesirable for paper sheet formation and additionally permits the occurrence of harmful “backwash” which comes from hydraulic pulses passing through the fabric from the machine side. The direct passage of these pulses disturbs the fragile cellulosic fibrous network.

GB 2,283,991 relates to papermachine clothing made from partially fused particles. A reinforcing structure is embedded within the structure. This papermachine clothing is suitable for pressing applications and possibly special forming applications.

A number of processes for three dimensional modelling of prototypes have been proposed and recently developed.

In particular xerography has been found to be applicable in this field, and a method and apparatus for this purpose has been described in U.S. Pat. No. 5,593,531 wherein a three dimensional prototype object is built up by super posing layers of fused dry material. The layers can be made by forming layers from the fused dry powder build material, and if necessary accompanied by a second material which would serve as a support matrix. This latter material is removable after completion of the object. This is carried out by projecting the desired image onto a charged drum or belt so that areas where the geometric pattern is to be developed is in a charged state in readiness for powder pickup. Unadhered powder is removed and that which adheres to selected areas is then subsequently fused at the point of deposition on to the previously made stack of laminates. To introduce support powder into the structure, the areas which were previously neutralized by the passage of light through a photo conductor on the drum's surface are re-charged. Once again unadhered powder is removed, that which remains being fused by heat. The layer, thus formed is transported on a conveyor, and deposited by thermal assistance on a stack of previous layers, the process being repeated until the object and its surrounding support is completed. The support material is then removed. In principle the process is similar to xerography as used in photocopying apparatus for example, except that in photocopying, further layers of toner are not applied to the page on which the copy is made.

### SUMMARY OF THE INVENTION

The present invention provides a method of manufacturing of papermachine clothing and other industrial fabrics, such as forming fabrics, press felts, dryer fabrics, through-air dryer (TAD) fabrics, hydroentanglement screens and transfer fabrics for use in a papermachine. The fabrics of the invention also have application as transfer/conveyor fabrics in machines other than papermachines and may be used, for example, as conveying fabrics, or as screens for latex impregnation of conventionally air-laid materials, for support or formation screens used in melt blowing or spun bonded nonwoven fabric manufacture.

The present invention provides a method and apparatus for manufacture of papermachine clothing utilizing an adaptation of xerograph processes.

The invention provides a method for manufacture of papermachine clothing including charging selected areas of an electrostatically chargeable surface, and applying a dry material to the surface. In this manner, the dry material is caused to adhere to the selected areas. The method further includes, removing unadhered material, fusing the dry material adhering to the selected areas and, at the same time, depositing the fused dry material on an extended surface to create an extended planar article.

The invention also provides an apparatus for the manufacture of papermachine clothing having an electrostatically chargeable surface, a device to charge the surface and to cause selected areas of the charged surface to become electrostatically discharged, a device to apply a dry material to the surface and to remove unadhered material, a fusing device to fuse the dry material that adheres to the remaining charged areas, and a device to deposit the fused dry material on an extended surface.

The method and apparatus may allow for deposition and fusing of a second dry material in the non-selected areas of the chargeable surface to act as a support matrix for the first dry material, the second dry material being a soluble or otherwise removable material.

The extended surface for deposition of the fused dry material may include a conveyor belt with a non-adherent coating, such as a fluoropolymer. Further, the device for the fused dry material may be arranged to move at least in the cross-machine direction to deposit successive panels of the fused dry material edge-to-edge across the width of the conveyor belt and return to an initial position to lay a next layer. The process can be repeated until a desired number of layers have been built up.

Alternatively, a plurality of depositing device may be provided, side by side across the width of the receiving conveyor belt, to lay respective panels of fused dry material next to each other from edge to edge, to provide an array of panels across the width of the belt. The conveyor belt may be operated to advance intermittently by the length of the panels in the machine direction of the conveyor belt.

The apparatus preferably includes a device for controlling the selection and electrostatic discharging of the selected areas of the charged surface. This device may include a computer or equivalent device programmed to control the scanning and on/off operation of an emitter of deionizing radiation, which can be precisely targeted to give a point resolution of the required fineness. This can be a suitable laser device arranged to emit a suitably tight pencil of radiation, to selectively discharge a charged coating on the surface.

The same master pattern or programs may be reused for successive exposures to produce panels of fused dry material which are layered to complete at least one row of panels across the width of a conveyor belt, forming a layer of fused material, and then replaced with another master if required for the next layer to be laid, and so on.

The invention is directed to a method of manufacturing papermachine clothing including electrostatically charging selected areas of an electrostatically chargeable surface. Applying a dry material to the surface, wherein the dry material adheres to the selected areas, then removing non-adhering material. Melting the dry material adhering to the selected areas, and applying the molten dry material to an extended surface to form a planar article.

According to another feature of the invention the melting of the dry material occurs at a same time as the molten dry material is applied to the extended surface. Further, the invention includes discharging certain electrostatically charged areas of the surface. Further still, the invention further comprises applying a second dry material, serving as a carrier matrix for the dry material, in non-selected areas of the surface. Wherein, the second dry material comprises a material that is at least one of soluble and removable from the dry material. Further, the extended surface comprises a conveyor belt with a non-stick coating.

According to another feature of the invention an apparatus for manufacturing papermachine clothing comprises an electrostatically chargeable surface. A charging device to charge the surface, so that selected areas of the surface are charged. An applicator unit to apply a dry material to the surface, as well as a removal device to remove non-adhering dry material from the surface. Further, a heater for melting the dry material adhering to the selected charged areas, and a device to apply the molten dry material to an extended surface. Further still, the extended surface comprises a conveyor belt with a non-stick coating. Moreover, the non-stick coating comprises a fluoropolymer.

According to another feature of the invention the application unit is structured and arranged for movement at least transverse to a machine run direction, so as to apply successive panels of the dry material from a edge to a edge over the width of the surface. Further, the application unit is structured and arranged to traverse from one edge of the surface to another and to return to an initial position to deposit a following layer. A control device is structured and arranged to control selection and electrostatic discharging of the selected areas of the surface. Further, the control device comprises a computer that is programmable to control scanning and on/off operation of an emitter of deionizing radiation.

According to another feature of the invention is an apparatus comprising at least one electrostatic charging device that electrostatically charges a surface. At least one discharging device that selectively discharges selected areas of the surface. At least one dispenser dispenses a material that adheres to the charged areas to form a panel. A melting device that melts the adhered material of the panel and a device to apply the panel to an extended surface forming a planar article.

According to another feature of the invention includes a device to apply a second material into areas of the discharged surface. Further, the second material is at least one of soluble and removable from the material. Further still, the extended surface comprises a conveyor belt with a non-stick coating. Wherein, at least one electrostatically charging device is a corona discharge device, and the at least one discharging device is a radiant energy source such as a computer controlled laser used to direct de-ionizing radiation onto the selected areas on the surface. Moreover, the material is a toner material in the form of a divided dry thermoplastic material. Further, at least a portion of the toner adheres to the electrostatically charged areas of the surface and at least a portion the toner does not adhere to the discharged selected areas. Further still, the portion of toner not adhered to the discharged selected areas is removed via at least one removal device. Also, the melting device fuses the material and second material, and the material provides the designed layer of the planar article and the second material is removable by one of dissolving in water and a solvent. Further, the second material is a support matrix for the material so as to prevent collapse of overhangs in succeeding layers of the material.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a diagrammatic view of a first apparatus for making papermachine clothing according to the invention;

FIG. 2 is a diagrammatic view of a second apparatus for making papermachine clothing according to the invention;

FIG. 3 is a diagrammatic view of a third embodiment of apparatus according to the invention;

FIG. 4 is a similar view of a further embodiment of apparatus according to the invention;

FIG. 5 is a fragmentary cross-section of a simple structure comprising or forming part of a papermachine clothing according to the invention, and

FIG. 6 is a representation of a simple form of mask for use in FIG. 3 or of imaged master sheet for use in FIG. 4 for making the structure according to FIG. 5 for example.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

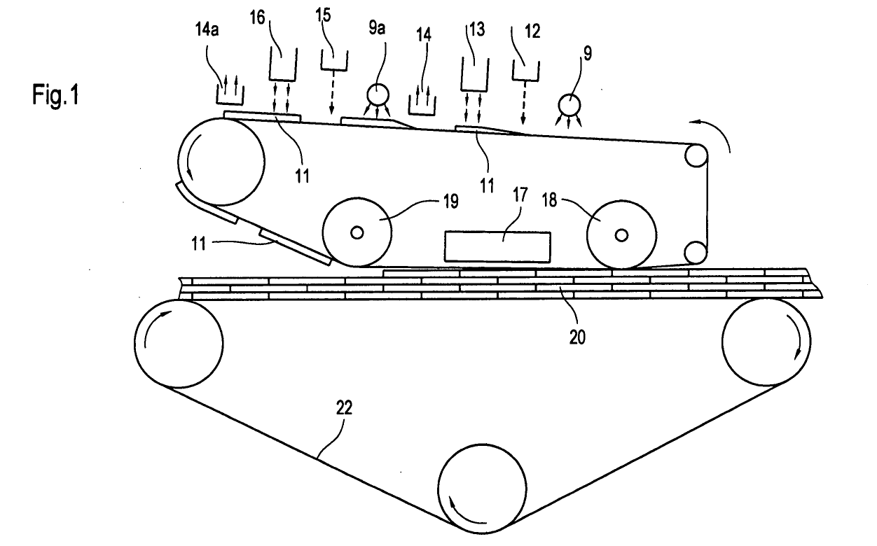

The apparatus shown in FIG. 1 comprises a support belt 10 which is initially electrostatically charged by a first corona discharge device 9. A first radiant energy source 12, such as a computer controlled laser is used to direct de-ionizing radiation onto selected areas of the panel 11 to discharge the selected areas in order to create a pattern of charged and uncharged zones on the panel. A toner material, in the form of a finely divided dry thermoplastic material is then spread on the panel or area 11 from a first dispenser 13. Toner adheres to the remaining electrostatically charged areas of the belt, while loose toner is removed by a first suction device 14. The process is then repeated with the areas which were not coated by the first toner material recharged by a second corona discharge device 9a, a second radiant energy source 15 and a second different toner material can be spread on the panel from a second dispenser 16 which adheres to these further charged areas. Unadhered toner is again removed by a second suction device 14a. The toners form an area or panel 11 of deposited toner on belt 10.

The area 11 bearing the two different toners is then passed under heating apparatus 17 which fuses both toners. The first toner material provides the designed layer of the paper machine fabric, and is of a first material while the second toner is a material which can be removed later, e.g. by dissolving in water or some other type of solvent. The second toner material is provided as a support matrix for the first toner, e.g., to prevent collapse of overhangs in succeeding layers.

After fusing, the areas 11 form panels which are applied in turn to a structure, such as a papermachine fabric 20 built up on an endless conveyor 22. The panels 11 are released under the heating apparatus 17 after passing under guide roll 19, and the conveyor 22 is advanced by one panel length between laying down of successive panels.

Alternatively, the panels 11 may be formed separately from support panels, each involving a single stage process with the panels 11 being brought together between formation and depositing on the belt 22.

The belt 10 is then passed below a cold roller 18 to return the belt 10 to its neutral temperature.

The device shown may be one of a plurality of such devices laying panels across the width of belt 22, or may be traversed laterally across the belt to lay panels 11 side by side possibly in overlapping relationship, before the belt 22 is moved forwards by a suitable distance to allow laying of the next row of panels possibly with a degree of overlap, to promote structural integrity.

Panels are preferably overlapped, e.g., by half a panel width/length in both the directions of movement of the belt to obtain the necessary structural integrity and strength for the finished structure.

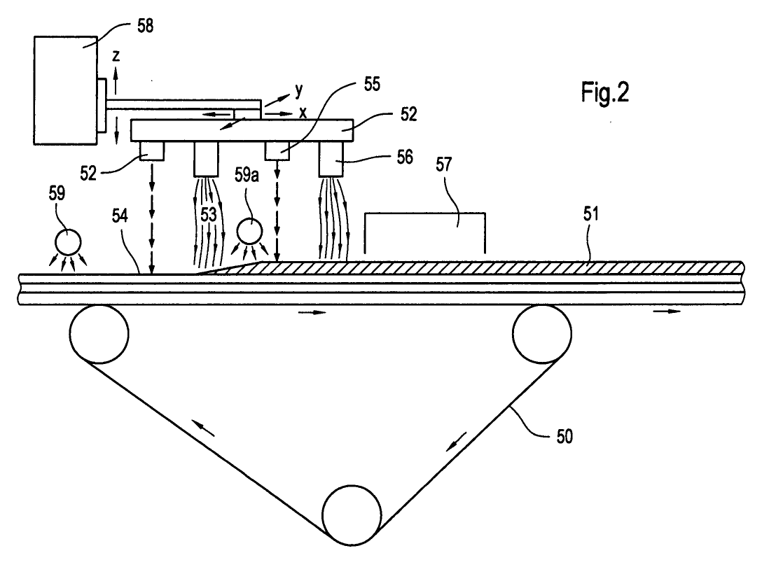

In FIG. 2 a second embodiment of apparatus according to the invention is shown diagrammatically. Here a conveyor 50 advances a fabric 51 in a process of manufacture to the right, while each layer of the fabric is built up in turn. The belt is charged by a first corona discharge device 59 and the fabric is advanced by exposing each area to a first imager 52, which selectively discharges areas of the belt. A first dry powder material from a dispenser 53 is applied to the upper surface 54 of the preceding (exposed) layer to adhere to the electrostatically charged areas of the surface 54 remaining after exposure from the first imager 52. Excess unadhered material is then removed and the belt is recharged using a second corona discharge device 59a, and passed under a second imager 55, to discharge different areas. A second dry powder material is applied from a second dispenser 56, and excess unadhered powder is removed before the layer passes under a heater 57 to fuse the dry powder materials. The second material is removed later to leave the intended structure of the papermachine fabric 51.

The first and second images 52, 55 and first and second dispensers 53, 56 are carried on a head 51 which is carried on a support structure 58. The first and second images 52, 55 and first and second dispensers 53, 56 are movable not only transversely of the conveyor 50, and in the lengthwise direction of the conveyor, but also up and down relative to the conveyor in the direction of arrows x, y and z respectively. These movements and the operation of the imagers are carried out under the control of a computer which may be operating a CAD program.

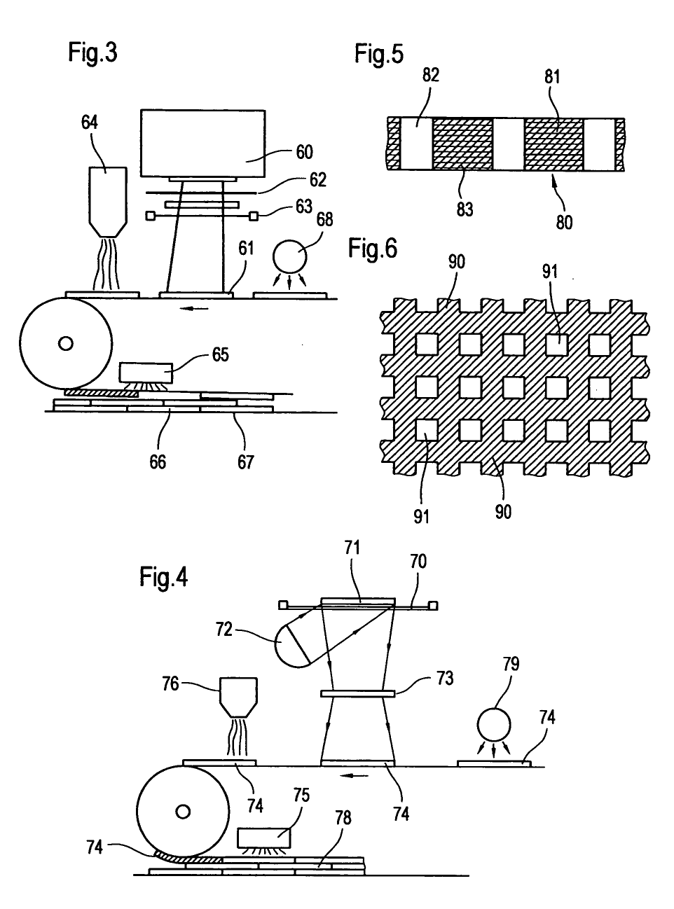

FIG. 3 is a partial illustration of an apparatus utilizing a light projection apparatus 60 to produce the required pattern of charged and uncharged areas on a panel 61, which has been precharged by a corona discharge device 68, using a mask 62 having translucent and opaque areas to selectively expose and discharge the panels 61. A shutter mechanism 63 is used to regulate the length of exposure. A dispenser for dry powder material 64 distributes material on the exposed panel 61, and excess unadhered powder may be removed. The powder is fused by exposure to a heat source such as a heater 65, as the panels are applied to a fabric 66, which is being built up on a conveyor 67 in a similar manner to FIG. 1 above.

FIG. 4 shows a variant, where a platten 70 carries a printed master 71 that is illuminated by a lamp 72. The reflected image is focused by a collimator lens system 73 upon a panel 74, which has been precharged by a corona discharge device 79. The master 71 bears a black and white printed image of the configuration of the layer, and may be provided on a paper or acetate transparency sheet. After exposure, the panel 74 is treated in the same way as in FIG. 3, i.e., with a dry powder from dispenser 76, fusing heater 75, and laid down into a fabric 78, preferably in an overlapping pattern as described in relation to FIG. 1.

FIG. 5 shows an exemplary embodiment of the invention of a cross section through a papermachine fabric or part thereof 80, in the form of a perforated membrane or mesh comprising lands 81 and apertures 82. The lands are built up from a plurality of layers 83. Machine direction or cross-direction reinforcing yarns can be incorporated into the structure within the lands 81.

FIG. 6 shows an exemplary embodiment of the invention of a portion of a mask 62 (from FIG. 3) or a printed master 71 (from FIG. 4) for use in fabricating a mesh or membrane according to FIG. 5. This comprises lands 90 and—apertures 91 (in the case of a mask), or inked areas 90 and blank spaces 91 which must be totally opaque to afford no transmission of light in the case of a printed master. Here again reinforcing yarns may be incorporated into the lands 90.

It will be appreciated that the structures produced by the invention are potentially far more complex, and fabrics may be created which comprise several different zones with different characteristics, superposed in a unitary structure. For example, in the FIG. 5 membrane, apertures 82 may be tapered by reducing the size thereof in each succeeding layer 83.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method of manufacturing papermachine clothing comprising:
electrostatically charging selected areas of an electrostatically chargeable surface;
applying a dry material to the surface, wherein the dry material adheres to the selected areas;
removing non-adhering material;
melting the dry material adhering to the selected areas; and
applying the molten dry material to an extended surface to form a planar article.

2. The method as claimed in claim 1, wherein the melting of the dry material occurs at a same time as the molten dry material is applied to the extended surface.

3. The method as claimed in claim 1, further comprising discharging certain electrostatically charged areas of the surface.

4. The method as claimed in claim 1, further comprising applying a second dry material, serving as a carrier matrix for the dry material, in non-selected areas of the surface.

5. The method as claimed in claim 4, wherein the second dry material comprises a material that is at least one of soluble and removable from the dry material.

6. The method as claimed in claim 1, wherein the extended surface comprises a conveyor belt with a non-stick coating.

7. An apparatus for manufacturing papermachine clothing comprising:
an electrostatically chargeable surface;
a charging device to charge the surface, so that selected areas of the surface are charged;
an applicator unit to apply a dry material to the surface;
a removal device to remove non-adhering dry material from the surface;
a heater for melting the dry material adhering to the selected charged areas, and
a device to apply the molten dry material to an extended surface.

8. The apparatus as claimed in claim 7, wherein the extended surface comprises a conveyor belt with a non-stick coating.

9. The apparatus as claimed in claim 8, wherein the non-stick coating comprises a fluoropolymer.

10. The apparatus as claimed in claim 7, wherein the application unit is structured and arranged for movement at least transverse to a machine run direction, so as to apply successive panels of the dry material from a edge to a edge over the width of the surface.

11. The apparatus as claimed in claim 7, wherein the application unit is structured and arranged to traverse from one edge of the surface to another and to return to an initial position to deposit a following layer.

12. The apparatus as claimed in claim 7, further comprising a control device structured and arranged to control selection and electrostatic discharging of the selected areas of the surface.

13. The apparatus as claimed in claim 12, wherein the control device comprises a computer that is programmable to control scanning and on/off operation of an emitter of deionizing radiation.

14. An apparatus comprising:
at least one electrostatic charging device that electrostatically charges a surface;
at least one discharging device that selectively discharges selected areas of the surface;
at least one dispenser dispenses a material that adheres to the charged areas to form a panel;
a melting device that melts the adhered material of the panel; and
a device to apply the panel to an extended surface forming a planar article.

15. The apparatus as claimed in claim 14, further comprising a device to apply a second material into areas of the discharged surface.

16. The apparatus as claimed in claim 15, wherein the second material is at least one of soluble and removable from the material.

17. The apparatus as claimed in claim 14, wherein the extended surface comprises a conveyor belt with a non-stick coating.

18. The apparatus as claimed in claim 14, wherein the at least one electrostatically charging device is a corona discharge device, and the at least one discharging device is a radiant energy source such as a computer controlled laser used to direct de-ionizing radiation onto the selected areas on the surface;

19. The apparatus as claimed in claim 14, wherein the material is a toner material in the form of a divided dry thermoplastic material.

20. The apparatus as claimed in claim 19, wherein at least a portion of the toner adheres to the electrostatically charged areas of the surface and at least a portion the toner does not adhere to the discharged selected areas.

21. The apparatus as claimed in claim 19, wherein the portion of toner not adhered to the discharged selected areas is removed via at least one removal device.

22. The apparatus as claimed in claim 14, wherein the melting device fuses the material and second material, and the material provides the designed layer of the planar article and the second material is removable by one of dissolving in water and a solvent.

23. The apparatus as claimed in claim 14, wherein the second material is a support matrix for the material so as to prevent collapse of overhangs in succeeding layers of the material.
